(19) United States
(12) Patent Application Publication
(10) Pub. No.: US 2007/0224482 A1
(43) Pub. Date: Sep. 27, 2007

(54) Fuel Cell System

(75) Inventors: Ryoichi Shimoi, Kanagawa (JP); Yoshitaka Ono, Kanagawa (JP)

Correspondence Address: GLOBAL IP COUNSELORS, LLP, 1233 20TH STREET, NW, SUITE 700, WASHINGTON, DC, 20036-2680, US

(73) Assignee: Nissan Motor Co., Ltd., Yokohama (JP)

(21) Appl. No.: 11/579,069

(22) PCT Filed: May 10, 2005
(86) PCT No.: PCT/IB05/01260

§ 371 Date: Oct. 27, 2006

(30) Foreign Application Priority Data
May 11, 2004 (JP) 2004-140933

(51) Int. Cl. H01M 8/00; H01M 8/04

(52) U.S. Cl. 429/33; 429/30

(57) ABSTRACT

To suppress a rapid voltage change in each power generation cell constituting a fuel cell stack, power storage devices 11 are respectively connected to each power generation cell 2 or each cell assembly including a plurality of power generation cells 2 of a fuel cell stack 1 to transfer electric charges between each power generation cell 2 and the corresponding power storage device 11. This allows a voltage control to be performed for each power generation cell 2, and thus improves the durability of the fuel cell stack.

This application claims the benefit of Japanese Application No. 2004-140933, filed May 11, 2004, the entirety of which is incorporated herein by reference.

### FIELD OF THE INVENTION

The present invention relates to a fuel cell system with a fuel cell stack in which a fuel gas reacts with an oxidizer gas to generate electric power.

### BACKGROUND OF THE INVENTION

A fuel cell system supplies a fuel gas such as a hydrogen gas and an oxidizer gas such as air to a fuel electrode (anode) and an oxidizer electrode (cathode), respectively, of each power generation cell constituting a fuel cell stack, and the hydrogen gas electrochemically reacts with oxygen gas in the fuel cell stack to obtain generated output. Such a fuel cell system has particularly large expectations for practical application as, for example, a source of power of an automobile, and presently research and development activities are being actively performed toward practical application.

As a fuel cell stack used for a fuel cell system, a proton-exchange membrane fuel cell stack is known as one particularly suitable for installation in an automobile. This proton-exchange membrane fuel cell stack has a film-like solid polymer membrane provided between a fuel electrode and an oxidizer electrode, wherein the solid polymer membrane functions as a hydrogen ion (proton) conductor.

As described above, the fuel cell system which obtains generated output by electrochemical reactions between hydrogen and oxygen in the fuel cell stack does not necessarily provide a satisfactory response to power generation in the fuel cell stack, and especially when used in an environment that requires a high response, such as a fuel cell vehicle, it needs to be assisted in some way or other. Therefore, in the fuel cell system to be installed in a vehicle or the like, a power storage unit such as a rechargeable battery is normally connected to the fuel cell stack so that when output power in the fuel cell stack is surplus to an external electrical load, the surplus is stored in the power storage unit and on the other hand, when the output power in the fuel cell stack runs short relative to the external electrical load, the shortage is offset by the power stored in the power storage device (for example, refer to Unexamined Japanese Patent Publication No. 2001-202973).

The above Publication describes a technology capable of coping with a rapid change in electrical load by providing a power storage section as a buffer of the fuel cell stack, and of securing a necessary storage capacity while reducing the number of cells of a rechargeable battery by arranging the power storage section in parallel with the rechargeable battery and a capacitor.

However, the technology described in the above document can help to cope with a rapid voltage change in the whole fuel cell stack, but cannot cope with a rapid voltage change in each individual power generation cell constituting the fuel cell stack. As a result, inside the fuel cell stack, a different voltage is applied to each power generation cell, and this may cause a phenomenon which deteriorates a catalyst layer, such as a carbon corrosion resulting from a lack of hydrogen, and consequently reduce durability of the fuel cell stack.

### SUMMARY OF THE INVENTION

The present invention has been proposed to solve the problems with the conventional technology described as above, and has an object to provide a fuel cell system which is capable of suppressing a rapid voltage change in each power generation cell constituting a fuel cell stack to improve the durability of the fuel cell stack.

A fuel cell system according to the present invention comprises a fuel cell stack formed by stacking a plurality of power generation cells one upon another, each of which includes a fuel electrode at one surface of an electrolyte and an oxidizer electrode at the other surface thereof and is formed by sandwiching these electrodes between a pair of separators, and is configured such that a power storage device is connected to each power generation cell or each cell assembly including the plurality of the power generation cells of the fuel cell stack.

Connecting the power storage device to each individual power generation cell constituting the fuel cell stack or each cell assembly including a plurality of power generation cells brings about transfer of electric charges between each power generation cell or cell assembly and the power storage device. Connecting the power storage section to the whole fuel cell stack, as has been conventional, has presented a problem of being unable to cope with a voltage change in each power generation cell constituting the fuel cell stack, but with the present invention, connecting the power storage device to each power generation cell or each cell assembly enables a voltage to be independently controlled in each power generation cell or each cell assembly. When, for example, a voltage of a particular power generation cell of the fuel cell stack drops, transfer of electrons from a power storage device connected to this power generation cell suppresses a rapid voltage drop. On the other hand, when a voltage of a particular power generation cell rises, transfer of electrons to the power storage device connected to this power generation cell suppresses a rapid voltage rise. Therefore, a rapid voltage change in each power generation cell or cell assembly is suppressed.

According to the fuel cell system in accordance with the present invention, the power storage device is connected to each power generation cell constituting the fuel cell stack or each cell assembly including a plurality of power generation cells, and consequently a rapid voltage change in each power generation cell or cell assembly is suppressed. Therefore, deterioration of a catalyst layer in the fuel cell stack resulting from such a rapid voltage change in each power generation cell or cell assembly can be effectively prevented, and a fuel cell system with a high durability can be thereby realized.

### BRIEF DESCRIPTION OF THE DRAWINGS

Preferred embodiments of a fuel cell system to which the present invention is applied will be described below with reference to the accompanying drawings.

FIG. 1 is a schematic diagram showing relevant parts of a fuel cell system in a first preferred embodiment.

FIG. 2 is an electrical circuit diagram of the parts shown in FIG. 1.

FIG. 3 is a schematic diagram showing relevant parts of a fuel cell system in a second preferred embodiment.

FIG. 4 is an electrical circuit diagram of the parts shown in FIG. 3.

FIG. 5 is an electrical circuit diagram of relevant parts of a fuel cell system in a third preferred embodiment.

FIG. 6 is a diagram illustrating a fuel cell system in a fourth preferred embodiment, which is a perspective view showing one example of a separator connected with a power storage device.

FIG. 7 is a diagram illustrating a fuel cell system in the fourth preferred embodiment, which is a perspective view showing another example of a separator connected with a power storage device.

FIG. 8 is a diagram illustrating a fuel cell system in a fifth preferred embodiment, which is a perspective view showing a separator connected with a power storage device.

FIG. 9 is a diagram illustrating a fuel cell system in a sixth preferred embodiment, which is a diagram schematically showing a stacked structure of a fuel cell stack.

FIG. 10 is an electrical circuit diagram of relevant parts of a fuel cell system in a seventh preferred embodiment.

FIG. 11 is an electrical circuit diagram of relevant parts of a fuel cell system in an eighth preferred embodiment.

FIG. 12 is a schematic block diagram showing a configuration of relevant parts of a fuel cell system in a ninth preferred embodiment.

FIG. 13 is a schematic block diagram showing a configuration of relevant parts of a fuel cell system in a tenth preferred embodiment.

FIG. 14 is a schematic diagram showing relevant parts of a fuel cell system in an eleventh preferred embodiment.

FIG. 15 is a diagram illustrating a fuel cell system in a twelfth preferred embodiment, which is a timing chart showing operating procedures for a system start-up.

FIG. 16 is a diagram illustrating a fuel cell system in a thirteenth preferred embodiment, which is a timing chart showing operating procedures for a system shutdown.

FIG. 17 is a schematic diagram showing relevant parts of a fuel cell system in a fourteenth preferred embodiment.

FIG. 18 is a schematic diagram showing relevant parts of a fuel cell system in a fifteenth preferred embodiment.

FIG. 19 is a schematic diagram showing relevant parts of a fuel cell system in a sixteenth preferred embodiment.

FIG. 20 is a schematic diagram showing relevant parts of a fuel cell system in a seventeenth preferred embodiment.

FIG. 21 is a diagram illustrating a fuel cell system in an eighteenth preferred embodiment, which is a plot showing a relationship between discharge time and voltage of a power storage device during a hydrogen pump operation.

### DETAILED DESCRIPTION OF THE INVENTION

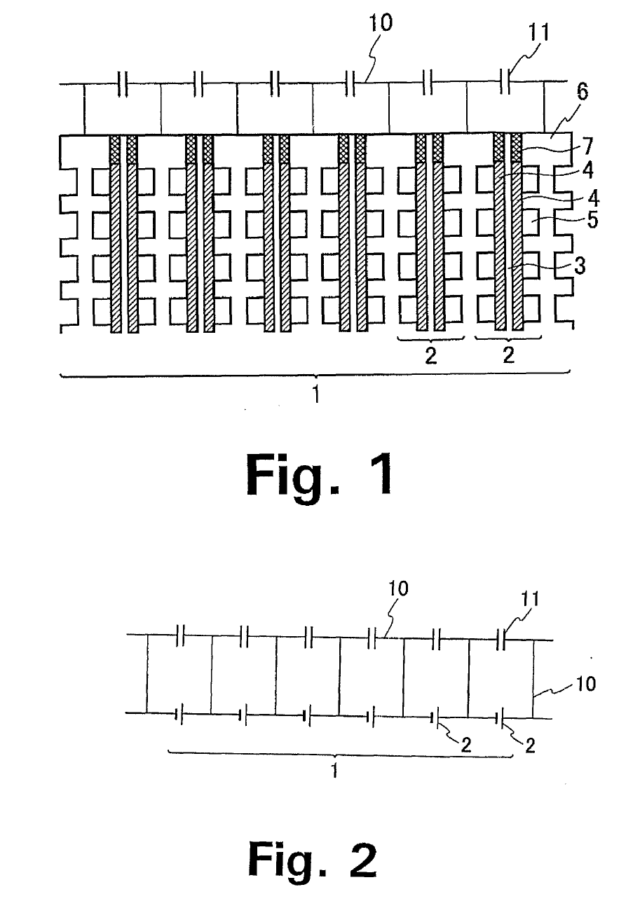

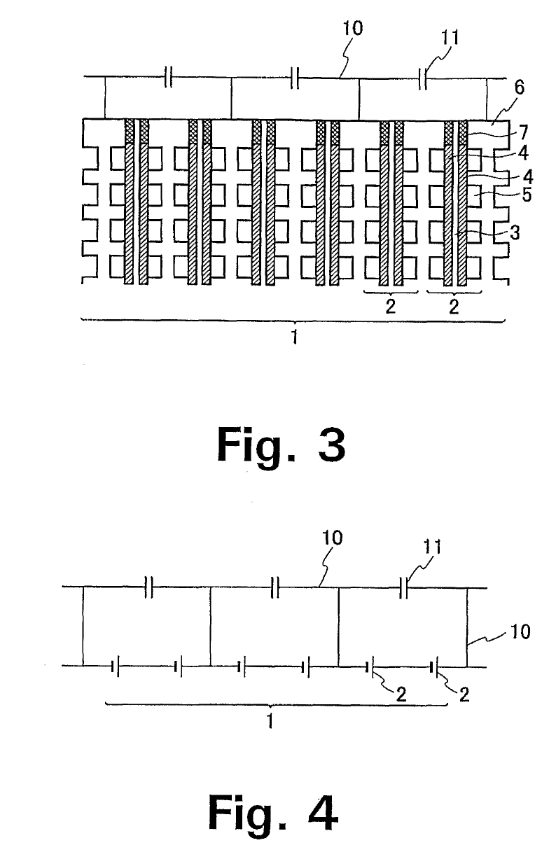

A first preferred embodiment of the fuel cell system to which the present invention is applied will be described with reference to FIGS. 1 and 2. FIG. 1 is a schematic diagram showing relevant parts of the fuel cell system in the present embodiment, and FIG. 2 is an electrical circuit diagram of the parts shown in FIG. 1.

The fuel cell system in the present embodiment comprises a fuel cell stack 1 as a power generation unit. In this fuel cell stack 1 oxygen electrochemically reacts in air supplied to an oxidizer electrode with hydrogen as a fuel gas supplied to a fuel electrode to generate electric power, and is formed by stacking a plurality of power generation cells 2 as a unit of power generation.

Each power generation cell 2 constituting the fuel cell stack 1 is constructed by sandwiching an electrolyte membrane 3 composed of a solid polymer membrane or the like and a membrane electrode junction composed of a pair of gas diffusion electrodes 4, each of the electrodes being arranged on each side thereof between a pair of separators 6 formed with gas flow channels 5 formed on both sides thereof. The pair of gas diffusion electrodes 4 includes a catalyst layer composed of platinum or platinum and any other metal and a gas diffusion layer, and is formed so that a surface on which the catalyst is present makes contact with the electrolyte membrane 3. In each power generation cell 2, one of the gas diffusion electrodes 4 is the fuel electrode (anode) and the other is the oxidizer electrode (cathode), and the fuel gas and oxidizer gas are supplied through the gas flow channels 5 formed in the separators 6 to the gas diffusion electrode 4 on the fuel electrode side and the gas diffusion electrode 4 on the oxidizer electrode side, respectively. In addition, a sealant 7 is provided at an outer peripheral end of the gas diffusion electrode 4 to prevent the gas from leaking therefrom.

With the fuel cell system in the present embodiment, power storage devices 11 are respectively connected through an electrical lead 10 to each power generation cell 2 of the fuel cell stack 1 constructed as above. Each power storage device 11 is connected in parallel with the corresponding power generation cell 2.

The power storage device 11 has a power storage function, and as the power storage device 11, for example, a condenser such as an aluminum electrolytic condenser, or a capacitor or the like such as a small electric double layer capacitor is used. When a condenser is used as the power storage device 11, the power storage device 11 can be produced easily and inexpensively, and moreover, a high reliability can be obtained. When a high-power capacitor is used as the power storage device 11, it is possible to downsize the power storage device 11. In addition, it is preferable that the power storage device 11 to be used should have an optimum capacity previously determined by calculation and that the capacity should be increased in proportion to a power generation area of the corresponding power generation cell 2.

The fuel cell system in the present embodiment, when carrying out power generation in the fuel cell stack 1, supplies the fuel cell stack 1 with hydrogen as a fuel gas from a fuel supply system (not shown) and air as an oxidizer gas from an oxidizer supply system (not shown), respectively. The hydrogen supplied to the fuel cell stack 1 is guided through the gas flow channels 5 formed in the separators 6 of each power generation cell 2 to the gas diffusion electrode 4 on the fuel electrode side, while the air supplied to the fuel cell stack 1 is guided through the gas flow channels 5 formed in the separators 6 of each power generation cell 2 to the gas diffusion electrode 4 on the oxidizer electrode side. On the fuel electrode side of each power generation cell 2, the hydrogen supplied is dissociated into hydrogen ions and electrons, and the hydrogen ions and electrons transfer through the electrolyte membrane 3 and an external circuit respectively to the oxidizer electrode side, generating power. On the oxidizer electrode side, oxygen in the air supplied reacts with the hydrogen ions and electrons to produce water.

With the fuel cell system in the present embodiment, a rapid voltage change in each power generation cell 2 is suppressed by keeping each power storage device 11 connected in parallel with each power generation cell 2 while power is being generated in the fuel cell stack 1. Namely, in the fuel cell system in the present embodiment, when a voltage of a particular power generation cell 2 drops, transfer of electrons from the power storage device 11 connected to this power generation cell 2 suppresses a rapid voltage drop in the relevant power generation cell 2. On the contrary, when a voltage of a particular power generation cell 2 rises, electrons transfer from this power generation cell 2 to the power storage device 11 and electric charges are accumulated in the power storage device 11, so that a rapid voltage rise in the relevant power generation cell 2 is suppressed. Therefore, the fuel cell system in the present embodiment can prevent deterioration of the catalyst layer caused by a rapid voltage change in a particular power generation cell 2 during power generation of the fuel cell stack 1 and achieve a high durability. Further, the fuel cell system in the present embodiment enables a stable operation because a voltage change during power generation of the fuel cell stack 1 is small.

Next, a second preferred embodiment of the fuel cell system to which the present invention is applied will be described with reference to FIGS. 3 and 4. FIG. 3 is a schematic diagram showing relevant parts of the fuel cell system in the present embodiment, and FIG. 4 is an electrical circuit diagram of the parts shown in FIG. 3.

The fuel cell system in the present embodiment is adapted, instead of connecting each power storage device 11 to each power generation cell 2 constituting the fuel cell stack 1 as in the above-mentioned first preferred embodiment, to connect each power storage device 11 to each cell assembly which combines a plurality of power generation cells 2. In addition, since the basic configuration of the fuel cell system in the present embodiment is the same as that of the first preferred embodiment, only distinctive aspects of the present embodiment will be described here.

In the fuel cell system in the present embodiment, the power storage devices 11 are respectively connected through the electrical lead 10 to cell assemblies, each of which includes two power generation cells 2 of the fuel cell stack 1. Each power storage device 11 is connected in parallel with the corresponding cell assembly. Here, by way of example, one power storage device 11 is connected to the cell assembly including two power generation cells 2, but the number of power generation cells 2 constituting a cell assembly may be three or more. It, however, is preferred that the power generation cells 2 constituting the cell assembly should be located so that a distance between a gas inlet portion of the fuel cell stack 1 and a gas outlet port of each separator 6 is about 2 cm at the maximum, wherein the timing of introduction of the fuel gas or oxidizer gas in each power generation cell 2 may be thought to be about the same time. Also, it is preferred that the number of cell assemblies in the whole fuel cell stack 1 should be at least 10 or more.

The fuel cell system in the present embodiment can also suppress a rapid voltage change on a cell assembly basis by keeping the power storage device 11 connected in parallel with each cell assembly while power is being generated as in the above-mentioned first preferred embodiment, and can effectively prevent the catalyst layer of the fuel cell stack 1 from deteriorating, thereby achieving an improved durability.

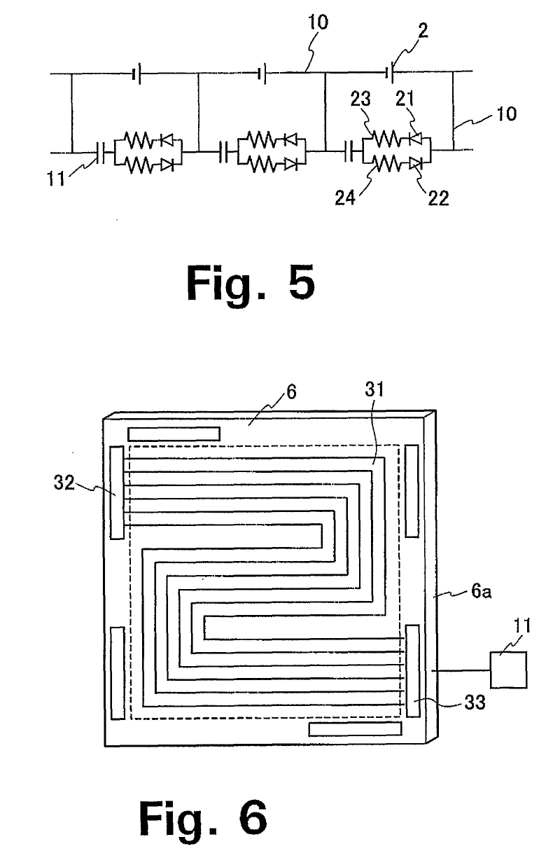

Next, a third preferred embodiment of the fuel cell system to which the present invention is applied will be described with reference to FIG. 5. FIG. 5 is an electrical circuit diagram of relevant parts of the fuel cell system in the present embodiment.

The fuel cell system in the present embodiment has the same basic configuration as the first preferred embodiment described above, wherein diodes 21, 22 and resistors 23, 24 are connected in series with each power storage device 11. In addition, an example of application to the fuel cell system having a configuration in which the power storage device 11 is connected to each power generation cell 2 (configuration in the first preferred embodiment) will be described here, but the present invention is effectively applicable to the fuel cell system having a configuration in which the power storage device 11 is connected to each cell assembly including a plurality of power generation cells 2 (configuration in the second preferred embodiment).

In the fuel cell system in the present embodiment, the power storage devices 11 are respectively connected through the electrical lead 10 in parallel with each power generation cell 2 of the fuel cell stack 1 as shown in FIG. 5, and the resistors 23, 24 having different resistance values and the diodes 21, 22 being mutually different in direction are connected respectively in series with each power storage device 11. Further, the resistor 23 and the diode 21 are connected in parallel with the resistor 24 and the diode 22.

In the fuel cell system in the present embodiment, connecting the resistors 23, 24 having different resistance values and the two diodes 24, 25 being different in direction in series with each power storage device 11 allows charging and discharging rates of the power storage device 11 to be changed. Therefore, with the fuel cell system in the present embodiment, in case of a voltage drop in the power generation cell 2 of the fuel cell stack 1, a rapid voltage drop can be suppressed by allowing electric charges to transfer quickly, while in case of a voltage rise in the power generation cell 2, a voltage recovery rate of the power generation cell 2 can be increased by allowing electric charges to transfer slowly to avoid preventing any voltage rise. Hence, the performance of the fuel cell stack 1 can be further stabilized.

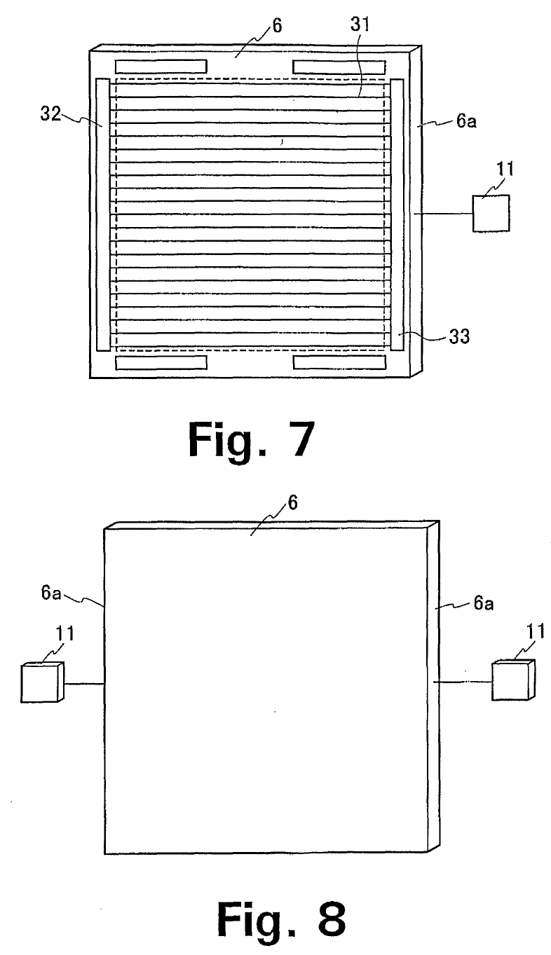

Next, a fourth preferred embodiment of the fuel cell system to which the present invention is applied will be described with reference to FIGS. 6 and 7. FIGS. 6 and 7 are perspective views showing the separator 6 used in the fuel cell stack 1 in the fuel cell system in the present embodiment.

The fuel cell system in the present embodiment is adapted to connect the power storage device 11 to the power generation cell 2 of the fuel cell stack 1 in the vicinity of an outlet portion of a flow channel through which the oxidizer gas flows (an oxidizer gas flow channel) among the gas flow channels 5 formed in the separator 6.

In the separator 6 shown in FIG. 6, an oxidizer gas flow channel 31 is formed in a meandering shape on a surface being in contact with the gas diffusion electrode 4 providing the oxidizer electrode. Further, in this separator 6, through an oxidizer gas inlet portion 32 flows the oxidizer gas through the oxidizer gas flow channel 31 and an oxidizer gas outlet portion 33 to exhaust the oxidizer gas from the oxidizer gas flow channel 31 are formed to pass through the separator 6 in a thickness direction thereof. In addition, the shape of the oxidizer gas flow channel 31 formed in the separator 6 is not particularly limited, and it may be of the shape of parallel flow channels as shown for example in FIG. 7. Also, the shape of the separator 6 is not limited to the nearly square one as shown in FIGS. 6 and 7, and may be a rectangle whose opposite sides are longer in one direction.

In the fuel cell system in the present embodiment, the power storage device 11 is connected to a position in the vicinity of the oxidizer gas outlet portion 33 on an outer peripheral wall 6a of the separator 6 as described above. By connecting, as just described, the power storage device 11 in the vicinity of the oxidizer gas outlet portion 33 of the separator 6 where a current density normally tends to be low, when a voltage of a particular power generation cell 2 drops, it is possible to transfer electric charges, while minimizing losses, to a position in the vicinity of the oxidizer gas outlet portion 33 where the current density decreases easily. Therefore, the fuel cell system in the present embodiment can suppress a rapid voltage drop in the power generation cell 2 more effectively.

Next, a fifth preferred embodiment of the fuel cell system to which the present invention is applied will be described with reference to FIG. 8. FIG. 8 is a perspective view showing the separator 6 used in the fuel cell stack 1 in the fuel cell system in the present embodiment.

The fuel cell system in the present embodiment is adapted to connect two power storage devices 11 to each power generation cell 2 or cell assembly of the fuel cell stack 1, with their connections located on opposite sides of the separator 6.

In the fuel cell system in the present embodiment, the power storage devices 11 are respectively connected to the outer peripheral walls 6a providing the opposite sides of the separator 6 as shown in FIG. 8. In addition, if three or more power storage devices 11 are connected, it is preferred that the power storage devices 11 are respectively connected to the outer peripheral wall 6a of each side of the separator 6. Especially when the separator 6 is formed in a rectangular shape, the power storage device 11 is preferably connected to all of the four sides and a plurality of power storage devices 11 may be connected to one side of the separator 6.

As described above, in the fuel cell system in the present embodiment, the power storage devices 11 are respectively connected to the outer peripheral walls 6a forming the opposite sides of the separator 6, and consequently it is possible to transfer electric charges to the whole power generation cell 2 while minimizing losses, thereby to suppress a rapid voltage drop in the power generation cell 2 more effectively.

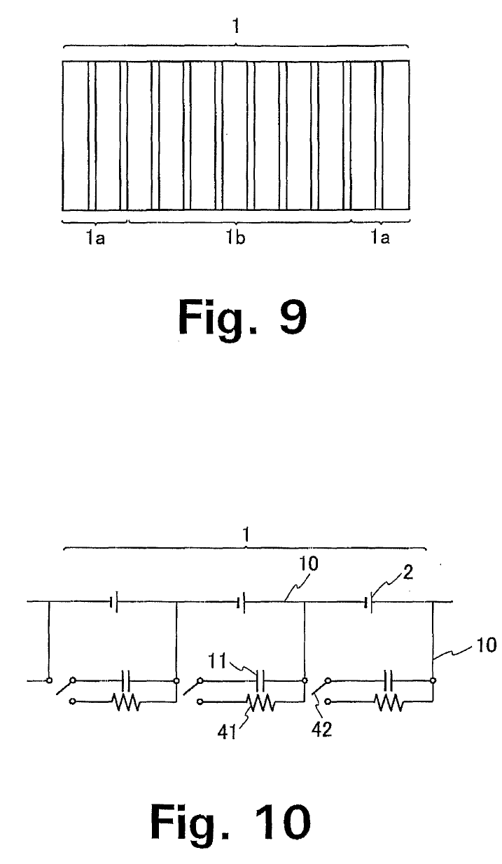

Next, a sixth preferred embodiment of the fuel cell system to which the present invention is applied will be described with reference to FIG. 9. FIG. 9 is a diagram schematically showing a stacked structure of the fuel cell stack 1 in the fuel cell system in the present embodiment.

The fuel cell system in the present embodiment is designed so that the total capacity of the power storage devices 11 connected to the power generation cells 2 (hereinafter referred to as end cells 1a) located in the vicinity of both ends in the stacking direction of the fuel cell stack 1 is greater than that of the power storage devices 11 connected to the power generation cells 2 (hereinafter referred to as center cells 1b) located in the other areas.

If, in the fuel cell stack 1, moisture in a gas is condensed and liquid water is accumulated in a gas flow channel, this liquid water will block flowing of the gas, causing a drop in the cell voltage. Such a phenomenon is called flooding, and this flooding tends to occur easily in the end cells 1a located at both ends in the stacking direction.

Then, the fuel cell system in the present embodiment ensures that the total capacity of the power storage devices 11 connected to the end cells 1a where flooding easily occurs is greater than that of the power storage devices 11 connected to the other center cells 1b so as to make it possible to effectively suppress a rapid voltage drop in the end cells 1a caused by flooding. Further, the number of end cells 1a in the fuel cell stack 1 is preferably about two to five at each end, but a greater number is allowed. In addition, as a method for increasing the total capacity of the power storage devices 11 connected to the end cells 1a, a technique of increasing the capacity of the power storage device 11 itself may be adopted, or a technique of increasing the number of power storage devices 11 to be connected may be adopted.

As described above, since the fuel cell system in the present embodiment ensures that the total capacity of the power storage devices 11 connected to the end cells 1a where flooding easily occurs is greater than that of the power storage devices 11 connected to the other center cells 1b, the fuel cell system can effectively suppress a rapid voltage drop in the end cells 1a caused by flooding while suppressing a considerable cost increase, which is of concern when the capacities of all of the power storage devices 11 are increased, and thereby to effectively prevent the catalyst layer from deteriorating.

Next, a seventh preferred embodiment of the fuel cell system to which the present invention is applied will be described with reference to FIG. 10. FIG. 10 is an electrical circuit diagram of relevant parts of the fuel cell system in the present embodiment.

The fuel cell system in the present embodiment has the same basic configuration as the first preferred embodiment described above, wherein a discharging resistor 41 as a discharge device to transfer electric charges in the power storage device 11 to discharge the power storage device 11 and a first switch 42 to make and break an electrical connection between the power storage device 11 and the discharging resistor 41 are connected in parallel with each power storage device 11. In addition, an example of application to the fuel cell system having a configuration in which the power storage device 11 is connected to each power generation cell 2 (configuration in the first preferred embodiment) will be described here, but the present invention is effectively applicable to the fuel cell system having a configuration in which the power storage device 11 is connected to each cell assembly including a plurality of power generation cells 2 (configuration in the second preferred embodiment).

In the fuel cell system in the present embodiment, the first switch 42 has, in addition to the function of making and breaking a connection between the power storage device 11 and the discharging resistor 41, the function of making and breaking a connection between the power storage device 11 and each power generation cell 2 of the fuel cell stack 1. This fuel cell system controls the voltage of the power generation cell 2 as in the above-mentioned first preferred embodiment by connecting each power generation cell 2 and the power storage device 11 in parallel using the first switch 42 while power is being generated by the fuel cell stack 1. Further, when the operation of the fuel cell stack 1 is stopped, the fuel cell system switches the first switch 42 to connect the power storage device 11 and the discharging resistor 41. This allows electric charges accumulated in the power storage device 11 with the power generation in the fuel cell stack 1 to be easily discharged by the discharging resistor 41.

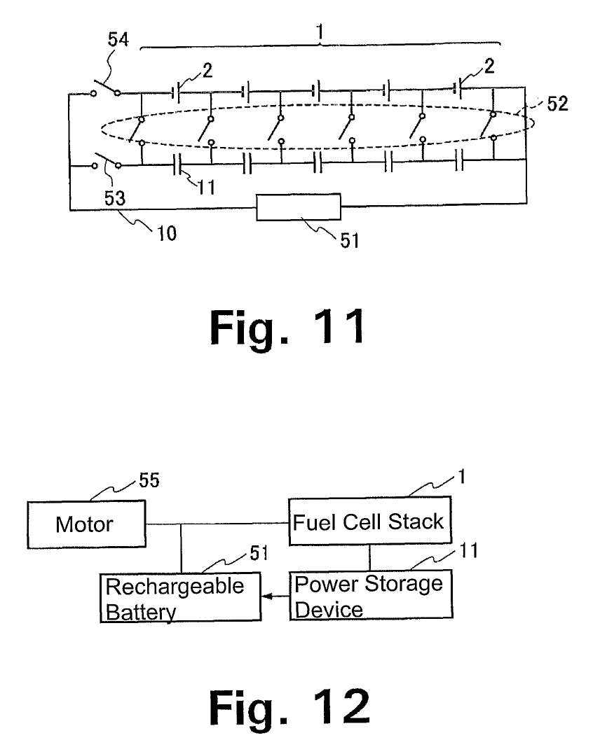

Next, an eighth preferred embodiment of the fuel cell system to which the present invention is applied will be described with reference to FIG. 11. FIG. 11 is an electrical circuit diagram of relevant parts of the fuel cell system in the present embodiment.

The fuel cell system in the present embodiment is adapted, instead of connecting the discharging resistors 41 as discharge devices respectively to each power generation cell 2 constituting the fuel cell stack 1 and each power storage device 11 connected thereto as in the above-mentioned seventh preferred embodiment, to connect a discharge device to the whole fuel cell stack 1 and the whole power storage device 11 and to use a rechargeable battery 51 as the discharge device.

In the fuel cell system in the present embodiment, second switches 52 are respectively disposed between the power generation cells 2 and the power storage devices 11 connected in parallel with the respective power generation cells 2 to make and break an electrical connection between these power generation cells 2 and the power storage devices 11. Also, in the fuel cell system in the present embodiment, the rechargeable battery 51 as a discharge device is connected to the whole fuel cell stack 1. Further, a capacitor may be used as the discharge device instead of the rechargeable battery 51.

Between the power storage devices 11 and the rechargeable battery 51, a first switch 53 is connected to make and break an electrical connection between these power storage devices 11 and the rechargeable battery 51, and also, between the fuel cell stack 1 and the rechargeable battery 51, a third switch 54 is connected to make and break an electrical connection between the fuel cell stack 1 and the rechargeable battery 51.

The fuel cell system in the present embodiment, when carrying out power generation by the fuel cell stack 1, closes the second switches 52 to connect each power generation cell 2 of the fuel cell stack 1 to the corresponding power storage device 11 to allow electric charges to transfer between each power generation cell 2 and the corresponding power storage device 11. At this time, the third switch 54 and the first switch 53 are in an open condition. Here, when a request to charge the rechargeable battery 51 is made, the system normally switches the second switches 52 to an open condition and the third switch 54 to a closed condition to connect the fuel cell stack 1 to the rechargeable battery 51 to charge the rechargeable battery 51, but if more energy is required or the power storage devices 11 need to be discharged, the system switches the first switch 53 to a closed condition to connect the power storage devices 11 to the rechargeable battery 51 in order to allow electric charges accumulated in the power storage devices 11 during the power generation in the fuel cell stack 1 to transfer to the rechargeable battery 51 to charge the rechargeable battery 51. In addition, if the electric charges in the power storage device 11 are reduced or lost, the system opens the first switch 53 again and closes the second switches 52 to charge the power storage devices 11.

As described above, in the fuel cell system in the present embodiment, the power storage devices 11 and the rechargeable battery 52 as a discharge device are connected via the first switch 53 and electric charges accumulated in the power storage devices 11 can be transferred to the rechargeable battery 52 as required, and accordingly it is possible to use the electric charges accumulated in the power storage devices 11 at any timing, thereby improving energy efficiency of the fuel cell system.

Next, a ninth preferred embodiment of the fuel cell system to which the present invention is applied will be described with reference to FIG. 12. FIG. 12 is a schematic block diagram showing a configuration of relevant parts of the fuel cell system in the present embodiment.

The fuel cell system in the present embodiment is an application of the eighth preferred embodiment described above, is adapted to consume electric charges accumulated in the power storage device 11 in an external load after transferring them to the rechargeable battery 51. As shown for example in FIG. 12, when a motor 55 as an external load is connected to the fuel cell stack 1 and the rechargeable battery 51, the motor 55 is supplied with electric power from the fuel cell stack 1 or the rechargeable battery 51. At this moment, electric charges accumulated in the power storage device 11 with the power generation in the fuel cell stack 1 are transferred to the rechargeable battery 51 as required to keep the rechargeable battery 51 charged. This allows the electric charges accumulated in the power storage device 11 and transferred to the rechargeable battery 51 to be supplied to the motor 55 at any timing and consumed in the motor 55, thus leading to an improvement in energy efficiency.

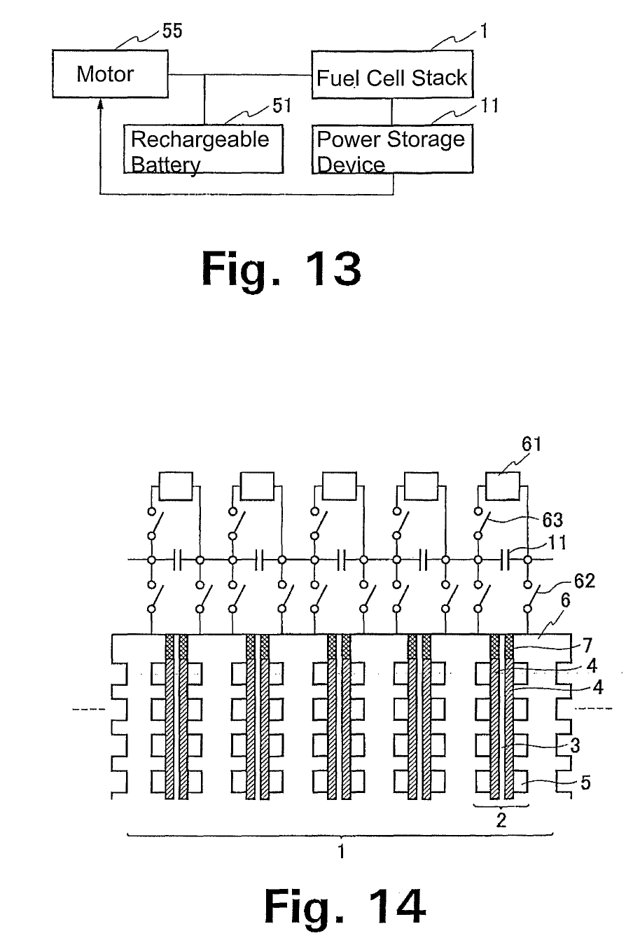

Next, a tenth preferred embodiment of the fuel cell system to which the present invention is applied will be described with reference to FIG. 13. FIG. 13 is a schematic block diagram showing a configuration of relevant parts of the fuel cell system in the present embodiment.

The fuel cell system in the present embodiment is a variation of the ninth preferred embodiment described above, and is adapted to supply electric charges accumulated in the power storage device 11 directly to an external load without the intervention of the rechargeable battery 52 so that they are consumed by the external load. As shown for example in FIG. 13, when the motor 55 as an external load is connected to the fuel cell stack 1 and the rechargeable battery 52, the motor 55 is normally supplied with electric power from the fuel cell stack 1 or the rechargeable battery 51. At this moment, electric charges are accumulated in the power storage device 11 with the power generation in the fuel cell stack 1, but the power supplied to the motor 55 can be temporarily increased by supplying the electric charges directly to the motor 55 as required. Therefore, the fuel cell system in the present embodiment is highly effective when output power requested by the motor 55 is temporarily increased, e.g. when a fuel cell vehicle is under hard acceleration.

Next, an eleventh preferred embodiment of the fuel cell system to which the present invention is applied will be described with reference to FIG. 14. FIG. 14 is a schematic diagram showing relevant parts of the fuel cell system in the present embodiment.

In the fuel cell system in the present embodiment, the power storage devices 11 are respectively disposed in parallel with each of the power generation cells 2 of the fuel cell stack 1 via second switches 62 connected in series with the relevant power generation cells 2. Further, discharge devices 61 are respectively connected in parallel with each of the power storage devices 11, and a first switch 63 is connected in series between each power storage device 11 and the corresponding discharge device 61.

With the fuel cell system in the present embodiment, since each second switch 62 disposed between each power generation cell 2 of the fuel cell stack 1 and the corresponding power storage device 11 is individually switchable, it is possible to transfer electric charges to the power storage device 11, when required, for each power generation cell 2. Similarly, since each first switch 63 disposed between each power storage device 11 and the corresponding discharge device is also individually switchable, it is possible to transfer electric charges to the discharge device 61, when required, for each power storage device 11.

As described above, in the fuel cell system in the present embodiment, the power storage device 11 is connected in parallel with each power generation cell 2 of the fuel cell stack 1 via the second switch 62 and the discharge device 61 is connected in parallel with each power storage device 11 via the first switch 63 in order to allow the second switch 62 and the first switch 63 to be individually switched, and therefore electric charges can be transferred from each power generation cell 2 to the power storage device 11 and also from the power storage device 11 to the discharge device 61 at any timing in accordance with a status of power generation in each power generation cell 2 of the fuel cell stack 1. Therefore, the fuel cell system in the present embodiment enables a close voltage control for each power generation cell 2 of the fuel cell stack 1 as well as an efficient use of energy, thus realizing a system with a an increased durability and improved energy efficiency.

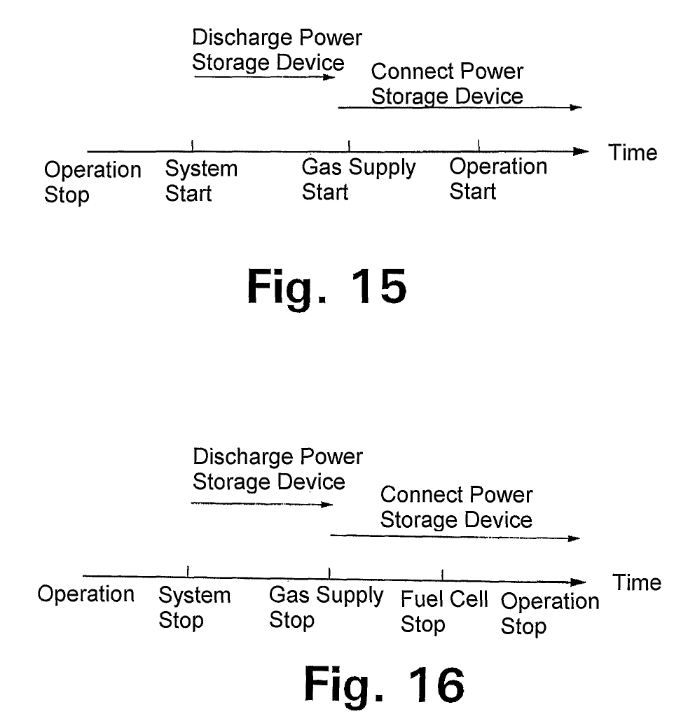

Next, a twelfth preferred embodiment of the fuel cell system to which the present invention is applied will be described with reference to FIG. 15. FIG. 15 is a timing chart showing operating procedures for a system start-up in the fuel cell system in the present embodiment.

The fuel cell system in the present embodiment has the same configuration as the eleventh preferred embodiment described above, and features operating procedures at a system start-up. The fuel cell system in the present embodiment, at a system start-up, first performs a control to close the first switch 63 and open the second switch 62 to connect each power storage device 11 to the corresponding discharge device 61 in order to allow electric charges accumulated in the power storage device 11 to be discharged by the discharge device 61. The system next performs a control to close the second switch 62 and open the first switch 63 to connect the discharged power storage device 11 to each power generation cell 2 of the fuel cell stack 1. Thereafter, the system supplies the fuel gas and oxidizer gas respectively to each power generation cell 2 of the fuel cell stack 1 for power generation.

In general, during storage after a fuel cell system shutdown, air which has entered the inside of a fuel cell stack through inlet portions of gas flow channels exists in the gas flow channels on a fuel electrode side of each power generation cell. And when, in this state, a system start-up is performed to introduce a fuel gas to each power generation cell of the fuel cell stack, a local battery is formed in the fuel electrode and as a result, there occurs a rise in electric potential of an oxidizer electrode, causing a problem of catalyst layer deterioration.

Then, the fuel cell system in the present embodiment, at a system start-up, connects the discharged power storage device 11 to each power generation cell 2 to secure a place to which electric charges are transferred before supplying the fuel gas and oxidizer gas to each power generation cell 2 of the fuel cell stack 1. This enables effectively suppressing a potential rise in the oxidizer electrode of each power generation cell 2 and preventing the catalyst layer from deteriorating, thereby improving the durability of the fuel cell system.

Next, a thirteenth preferred embodiment of the fuel cell system to which the present invention is applied will be described with reference to FIG. 16. FIG. 16 is a timing chart showing operating procedures for a system shutdown in the fuel cell system in the present embodiment.

The fuel cell system in the present embodiment has the same configuration as the eleventh preferred embodiment described above, and features operating procedures at a system shutdown. The fuel cell system in the present embodiment, at a system shutdown, first performs a control to close the first switches 63 to connect each power storage device 11 to the corresponding discharge device 61 in order to allow electric charges accumulated in the power storage device 11 to be discharged by the discharge device 61. The system next performs a control to open the second switches 62 after or at the same time as stopping the supply of the fuel gas and oxidizer gas to each power generation cell 2 of the fuel cell stack 1 to connect each of the discharged power storage devices 11 to each power generation cell 2 of the fuel cell stack 1.

In general, immediately after the operation of a fuel cell system is stopped, an open-circuit voltage in each power generation cell of a fuel cell stack is excessively high, and if this state continues, a catalyst layer of the fuel cell stack may deteriorate during storage. Then, the fuel cell system in the present embodiment, at a system shutdown, connects the discharged power storage device 11 to each power generation cell 2 of the fuel cell stack 1 to transfer electric charges in each power generation cell 2 to the power storage device 11 in order to allow the relevant voltage to be decreased and thereby the catalyst layer to be prevented from deteriorating. Additionally, as described above, during storage after a system shutdown, air enters the gas flow channels on the fuel electrode side of each power generation cell of the fuel cell stack, and consequently this air reacts with a residual fuel gas in the fuel electrode to form a local battery, which results in a rise in electric potential of the oxidizer electrode, leading to a concern about deterioration of the catalyst layer. However, since the fuel cell system in the present embodiment can transfer electric charges in each cell 2 of the fuel cell stack 1 to the power storage device 11, it is possible to decrease the electric potential in the oxidizer electrode and thereby effectively inhibit the deterioration of the catalyst layer.

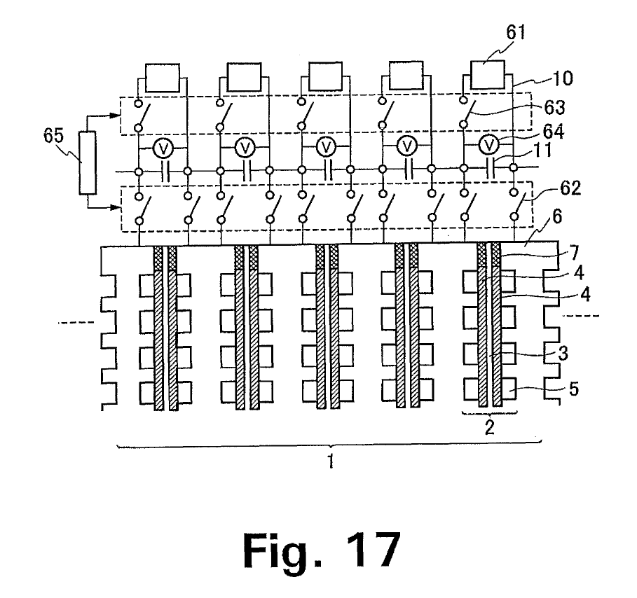

Next, a fourteenth preferred embodiment of the fuel cell system to which the present invention is applied will be described with reference to FIG. 17. FIG. 17 is a schematic diagram showing relevant parts of the fuel cell system in the present embodiment.

The fuel cell system in the present embodiment has the same basic configuration as the eleventh preferred embodiment described above, wherein voltage detectors 64 are respectively connected in parallel with each power storage device 11.

In the fuel cell system in the present embodiment, voltages of each power storage device 11 connected to each power generation cell 2 of the fuel cell stack 1 are respectively detected by the corresponding voltage detectors 64. And the values detected by these voltage detectors 64 are programmed to be sent to a controller 65 which conducts an operational control of the fuel cell system.

The controller 65 monitors the values detected by the voltage detectors 64. When the controller 65 judges that the voltage of a power storage device 11 exceeds a predetermined value, the controller 65 performs a control to close the first switch 63 between the relevant power storage device 11 and the discharge device 61 to allow electric charges accumulated in the power storage device 11 to be discharged by the discharge device 61. Here, the predetermined value is set to a voltage at which carbon corrosion or the like occurs easily in the catalyst layer of the fuel cell stack 1, for example 0.6 V. As a result, when a situation occurs where there is concern about deterioration of the catalyst layer of the fuel cell stack 1, the fuel cell system in the present embodiment can secure a place to which electric charges are transferred by decreasing the voltage of the power storage device 11, thus preventing the catalyst layer of the fuel cell stack 1 from deteriorating more reliably.

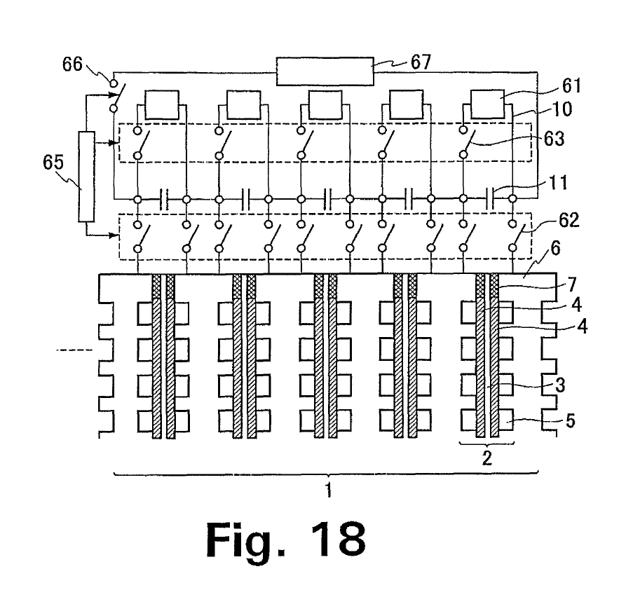

Next, a fifteenth preferred embodiment of the fuel cell system to which the present invention is applied will be described with reference to FIG. 18. FIG. 18 is a schematic diagram showing relevant parts of the fuel cell system in the present embodiment.

The fuel cell system in the present embodiment is an application of the eleventh preferred embodiment described above, and is adapted to perform a hydrogen pump operation using the power storage device 11 as a power source at a system start-up. Here, the hydrogen pump operation means a process where after a negative electrode and a positive electrode of the power source are connected to the fuel electrode side and the oxidizer electrode side of the power generation cell 2 of the fuel cell stack 1 respectively, a voltage is applied to the power generation cell 2 and a hydrogen gas is introduced into the oxidizer gas flow channel to transfer water to the fuel electrode side with transfer of protons in the electrolyte membrane 3 and thereby reduce the amount of water present in the oxidizer electrode side.

In order to enable the hydrogen pump operation using the power storage device 11 as a power source, the fuel cell system in the present embodiment connects a rechargeable battery 67 to the whole power storage device 11 via a third switch 66 and closes the third switch 66 under control of the controller 65 to transfer electric charges in the rechargeable battery 67 to each power storage device 11 in order to allow the power storage device 11 to be charged.

In the fuel cell system in the present embodiment, at a system start-up, the controller 65 first performs a control to close the third switch 66 and open the second switches 62 to connect the rechargeable battery 67 in series with each power storage device 11 to charge each power storage device 11. The controller 65 next performs a control to open the third switch 66 and close the second switches 62 to connect each of the charged power storage devices 11 in parallel with each power generation cell 2 of the fuel cell stack 1 to perform a hydrogen pump operation. More particularly, each power storage device 11 and the power generation cell 2 are connected so that a negative electrode of each power storage device 11 is connected to the fuel cell side of the power generation cell 2 and a positive electrode of the power storage device 11 is connected to the oxidizer electrode side of the power generation cell 2, wherein a voltage is applied to each power generation cell 2 and a hydrogen gas is introduced into the oxidizer gas flow channel. This allows water in the electrolyte membrane 3 of each power generation cell 2 to be transferred to the fuel electrode side, accompanied by protons, thus making it possible to reduce the amount of water present in the oxidizer electrode side.

In a conventional fuel cell system, a power storage device is placed with respect to the whole fuel cell stack and an electric current is passed through the whole fuel cell stack for averaging water in an electrolyte membrane. When such operation is performed, there is concern that depending on the conditions of components of a power generation cell such as an electrolyte membrane, a different voltage will be applied to each power generation cell, leading to deterioration of a catalyst layer. On the contrary, the fuel cell system in the present embodiment is adapted to perform a hydrogen pump operation using as a power source the power storage device 11 connected in parallel with each power generation cell 2, so that a uniform voltage can be applied to each power generation cell 2 by the power storage device 11 and consequently deterioration of the catalyst layer incident to the hydrogen pump operation can be inhibited. Further, the hydrogen pump operation can equally bring the electrolyte membrane 3 to a favorable moisture condition between each power generation cell 2, thus realizing a deterioration-resistant, stable start-up.

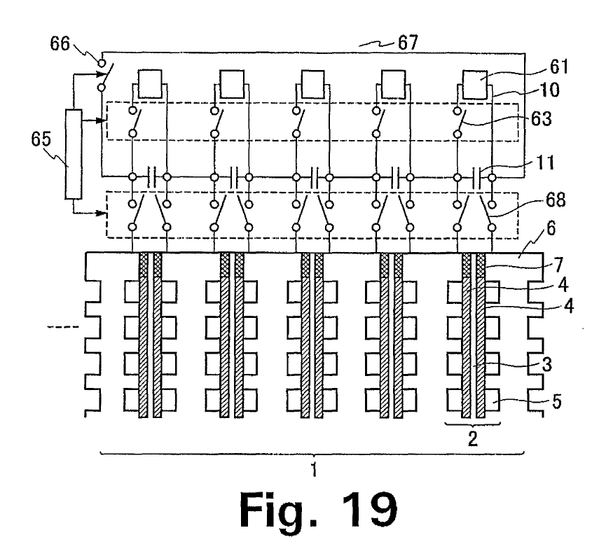

Next, a sixteenth preferred embodiment of the fuel cell system to which the present invention is applied will be described with reference to FIG. 19. FIG. 19 is a schematic diagram showing relevant parts of the fuel cell system in the present embodiment.

The fuel cell system in the present embodiment is a variation of the fifteenth preferred embodiment described above, and is adapted to use a switch 68 capable of connecting the power storage device 11 with its positive and negative electrodes reversed to each power generation cell 2 of the fuel cell stack 1 as a second switch to connect each power storage device 11 and the corresponding power generation cell 2.

In the fuel cell system in the present embodiment, between each power generation cell 2 of the fuel cell stack 1 and the power storage device 11, the switch 68 is disposed, which is capable of connecting the power generation cell 2 and the power storage device 11 with its positive and negative electrodes reversed. More specifically, the switch 68 enables switching between two states: one is a state where the negative electrode of the power storage device 11 is connected to the fuel electrode side of the power generation cell 2 and the positive electrode of the power storage device 11 to the oxidizer electrode side of the power generation cell 2, and the other is a state where the negative electrode of the power storage device 11 is connected to the oxidizer electrode side of the power generation cell 2 and the positive electrode of the power storage device 11 is connected to the he fuel electrode side of the power generation cell.

The fuel cell system in the present embodiment performs, at a system start-up, a hydrogen pump operation using the power storage device 11 as a power source as in the fifteenth preferred embodiment described above. That is, the fuel cell system first performs a control to close the third switch 66 and open the second switches 68 to connect the rechargeable battery 67 in parallel with each power storage device 11 to charge each power storage device 11. The system next opens the third switch 66 and controls the switches 68 so that the negative electrode of the power storage device 11 is connected to the fuel electrode side of the power generation cell 2 and the positive electrode of the power storage device 11 is connected to the oxidizer electrode side of the power generation cell 2 to connect the charged power storage device 11 in parallel with each power generation cell 2. Further, the system introduces a hydrogen gas into the oxidizer gas flow channel of each power generation cell 2. This allows water in the electrolyte membrane 3 of each power generation cell 2 to be transferred to the fuel electrode side, accompanied by protons, thus making it possible to reduce the amount of water present in the oxidizer electrode side.

Moreover, when the gas flow channel on the fuel electrode side of each power generation cell 2 is filled with the hydrogen gas as a fuel gas, the fuel cell system in the present embodiment reverses the switches 68 to perform a control so that the negative electrode of the power storage device 11 is connected to the oxidizer electrode side of the power generation cell 2 and the positive electrode of the power storage device 11 is connected to the fuel electrode side of the power generation cell 2. Applying thus a reverse voltage to the above-mentioned direction to each power generation cell 2 with the gas flow channel on the fuel electrode side of the power generation cell 2 filled with the hydrogen gas as a fuel gas allows a hydrogen pump operation in a direction reverse to the above-mentioned one, namely, allows water in the electrolyte membrane 3 to be transferred to the oxidizer electrode side with transfer of protons, thereby decreasing the electric potential in the oxidizer electrode of each power generation cell 2. This enables the catalyst layer of the oxidizer electrode to be reduced and thus deterioration of the catalyst layer to be inhibited.

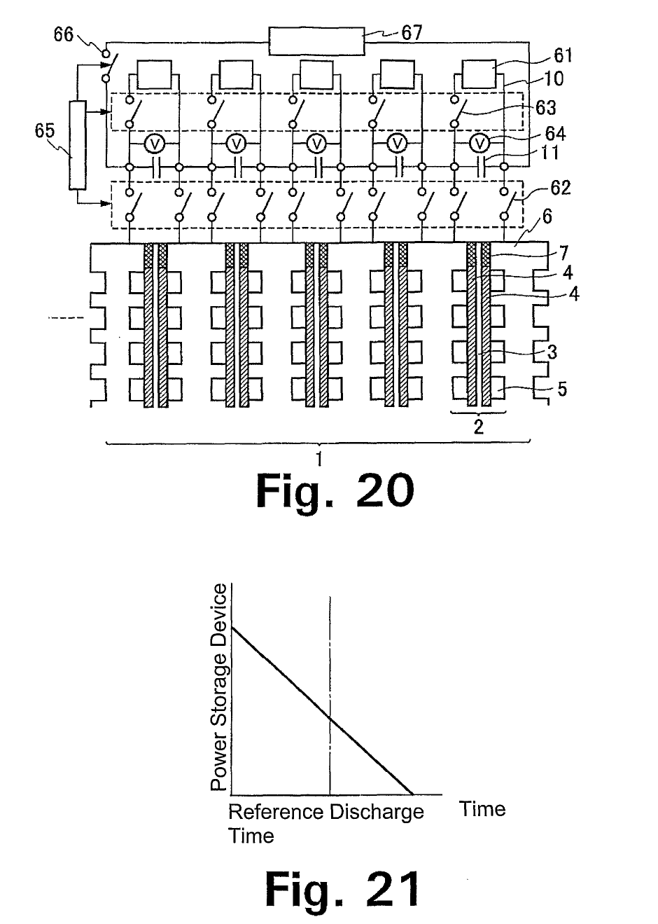

Next, a seventeenth preferred embodiment of the fuel cell system to which the present invention is applied will be described with reference to FIG. 20. FIG. 20 is a schematic diagram showing relevant parts of the fuel cell system in the present embodiment.

The fuel cell system in the present embodiment has the same basic configuration as the fifteenth preferred embodiment described above, wherein the voltage detectors 64 are respectively connected in parallel with each power storage device 11.

In the fuel cell system in the present embodiment, voltages of each power storage device 11 connected to each power generation cell 2 of the fuel cell stack 1 are respectively detected by the corresponding voltage detectors 64. And the values detected by the voltage detectors 64 are programmed to be sent to the controller 65.

The controller 65 reads, prior to performing the above-mentioned hydrogen pump operation at a system start-up, the values detected by the voltage detectors 64 to judge the voltage of each power storage device 11. And the controller 65 performs the above-mentioned hydrogen pump operation only with respect to the power generation cell 2 corresponding to the power storage device 11 whose voltage value is greater than or equal to a predetermined value, e.g. 0.5 V and does not perform the above-mentioned hydrogen pump operation with respect to the power generation cell 2 corresponding to the power storage device 11 whose voltage value is below the predetermined value.

When, in a certain power generation cell in the fuel cell stack, the supply of the hydrogen gas is interrupted from any cause, if the predetermined voltage is applied to the relevant power generation cell by the above-mentioned hydrogen pump operation, carbon and water react to produce carbon dioxide, protons and electrons in the catalyst layer, from which the protons are transferred. And this reaction may cause corrosion in the relevant catalyst layer, resulting in a significant deterioration. On the contrary, the fuel cell system in the present embodiment detects the voltages of the power storage devices 11 in advance and does not perform the hydrogen pump operation with respect to the power generation cell 2 corresponding to the power storage device 11 whose voltage is below the predetermined value, and therefore it is possible to effectively avoid a problem such as carbon elution associated with the hydrogen pump operation and to prevent the catalyst layer from deteriorating, thus improving the durability.

Next, an eighteenth preferred embodiment of the fuel cell system to which the present invention is applied will be described.

The fuel cell system in the present embodiment is an application of the seventeenth preferred embodiment described above, and is adapted to detect voltage changes of the power storage devices 11 during a hydrogen pump operation and to perform the hydrogen pump operation again with respect to the power generation cell 2 corresponding to the power storage device 11 whose voltage change rate is below a predetermined rate.

In the fuel cell system in the present embodiment, during the hydrogen pump operation at a system start-up, the controller 65 monitors the values detected by the voltage detectors 64 to judge a voltage change of each power storage device 11. And as shown for example in FIG. 21, when a voltage change rate of a power storage device 11 performing the hydrogen pump operation is less than or equal to a predetermined rate, i.e. when the voltage value of the power storage device 11 fails to drop adequately even if a predetermined discharge time (reference discharge time) has passed, the controller 65 judges that the electrolyte membrane 3 of the power generation cell 2 corresponding to the relevant power storage device 11 has a high membrane resistance and performs the hydrogen pump operation one more time.

In general, when the moisture condition in the thickness direction of the electrolyte membrane 3 in the power generation cell 2 is not completely uniform, the voltage change of the power storage device 11 immediately after starting the hydrogen pump operation is slow because the resistance of such electrolyte membrane is higher than that of the electrolyte membrane 3 being in a uniform moisture condition. Then, with respect to the power generation cell 2 corresponding to the power storage device 11 whose voltage change rate is less than or equal to the predetermined rate, the fuel cell system in the present embodiment is adapted to judge that the electrolyte membrane 3 is not in a completely uniform moisture condition in the thickness direction and to perform the hydrogen pump operation one more time. By repeating this, the electrolyte membrane 3 in each power generation cell 2 in the fuel cell stack 1 will be in a uniform moisture condition in the thickness direction and a uniform power generation will take place between each power generation cell 2. This makes it possible to realize a fuel cell system with a stable start-up and a high durability.

### DESCRIPTION OF REFERENCE NUMERALS

1: FUEL CELL STACK
2: POWER GENERATION CELL
3: ELECTROLYTE MEMBRANE
4: GAS DIFFUSION ELECTRODE
5: GAS FLOW CHANNEL
6: SEPARATOR
10: ELECTRICAL LEAD
11: POWER STORAGE DEVICE
21, 22: DIODE
23, 24: RESISTOR
41: DISCHARGING RESISTOR
42: FIRST SWITCH
51: RECHARGEABLE BATTERY
52: SECOND SWITCH
53: FIRST SWITCH
61: DISCHARGE DEVICE
62: SECOND SWITCH
63: FIRST SWITCH
64: VOLTAGE DETECTOR
65: CONTROLLER
67: RECHARGEABLE BATTERY
68: SWITCH

What is claimed:

1. A fuel cell system, comprising:
a fuel cell stack formed of a plurality of power generation cells stacked sequentially, each of the power generation cells including an electrolyte membrane having two surfaces and a pair of separators sandwiching the electrolyte membrane, one of the two surfaces having a fuel electrode and the other of the two surfaces having an oxidizer electrode; and
a plurality of power storage devices, at least one of the power storage devices being connected to each of the power generation cells or cell assemblies formed of at least two of the power generation cells.

2. A fuel cell system according to claim 1, wherein each of the power storage devices includes an aluminum electrolytic condenser.

3. A fuel cell system according to claim 1, wherein each of the power storage devices includes an electric double layer capacitor.

4. A fuel cell system according to claim 1, further comprising a first resistor and a first diode connected to each of the power storage devices in series, and a second resistor and a second diode connected to the first resistor and the first diode in parallel and connected to each of the power storage devices in series, the first diode and the second diode being connected in opposite directions.

5. A fuel cell system according to claim 1, wherein at least one of the separators includes an oxidizer gas flow channel for supplying an oxidizer gas to the oxidizer electrode, and at least one of the power storage devices is connected to each of the power generation cells at a position close to an outlet portion of the oxidizer gas flow channel.

6. A fuel cell system according to claim 1, wherein at least one of the power storage devices is connected to each power generation cell on the outer periphery on one side of the power generation cell, and another power storage device is connected to the power generation cell on the outer periphery of the opposite side.

7. A fuel cell system according to claim 1, wherein at least two of the power storage devices are respectively connected to two of the power generation cells located adjacent to both ends of the fuel cell stack, with the at least two of the power storage devices having a total capacity greater than that of all of the power storage devices other than the at least two of the power storage devices.

8. A fuel cell system according to claim 1, further comprising a discharge device connected to at least one of the power storage devices in parallel for discharging the at least one of the power storage devices and a first switch connected between the discharge device and the at least one of the power storage devices for switching the discharge device.

9. A fuel cell system according to claim 8, wherein the discharge device is connected to each of the power storage devices.

10. A fuel cell system according to claim 8, wherein the discharge device is connected to all of the power storage devices.

11. A fuel cell system according to claim 8, further comprising a second switch connected between each of the power storage devices and each of the power generation cells or the cell assemblies.

12. A fuel cell system according to claim 11, wherein the first switch is closed so that the discharge device discharges electric charge accumulated in the at least one of the power storage devices when the fuel cell system is started, and the second switches are closed to connect the power generation cells or cell assemblies to the power storage devices so that a fuel gas and an oxidizer gas are supplied to the power generation cells.

13. A fuel cell system according to claim 11, wherein the first switch is closed so that the discharge device discharges electric charge accumulated in the at least one of the power storage devices when the fuel cell system is started, and the second switches are closed to connect the power generation cells or the cell assemblies to the power storage devices after a fuel gas and an oxidizer gas supplied to the power generation cells are stopped.

14. A fuel cell system according to claim 11, further comprising a voltage detector connected to the at least one of the power storage devices for detecting a voltage of the at least one of the power storage devices, the first switch being closed to connect the at least one of the power storage devices to the discharge device when the voltage detector detects a voltage greater than a predetermined value.

15. A fuel cell system according to claim 1, wherein the at least one of the power storage devices accumulates electric charge and is connected to the each of the power generation cells or the cell assemblies such that a negative electrode of the at least one of the power storage devices is connected to the fuel electrode and a positive electrode thereof is connected to the oxidizer electrode, and a fuel gas is introduced into the each of the power generation cells to perform a hydrogen pump operation when the fuel cell system is started.

16. A fuel cell system according to claim 15, further comprising a reverse switch connected between the at least one of the power storage devices and the each of the power generation cells or the cell assemblies for switching between the positive and negative electrodes of the at least one of the power storage devices to be connected to the each of the power generation cells or the cell assemblies.

17. A fuel cell system according to claim 15, further comprising a voltage detector connected to the at least one of the power storage devices for detecting a voltage of the at least one of the power storage devices, wherein the hydrogen pump operation is not performed relative to the each of the power generation cells or the cell assemblies when the voltage detector detects a voltage less than a predetermined value.

18. A fuel cell system according to claim 15, further comprising a voltage detector connected to the at least one of the power storage devices for detecting a voltage of the at least one of the power storage devices, wherein the hydrogen pump operation is performed one more time relative to the each of the power generation cells or the cell assemblies when the voltage detector detects a change rate of the voltage less than a predetermined rate while the hydrogen pump operation is being performed.
